(19) United States
(12) Patent Application Publication
(10) Pub. No.: US 2003/0232308 A1
(43) Pub. Date: Dec. 18, 2003

(54) Method and apparatus for dental implants

(76) Inventor: Earl Wayne Simmons JR., San Antonio, TX (US)

Correspondence Address: Dennis Braswell, 105 Soost Court, Mobile, AL, 36608, US

(21) Appl. No.: 10/171,825

(22) Filed: Jun. 14, 2002

(51) Int. Cl. A61C 8/00

(52) U.S. Cl. 433/173; 433/174

(57) ABSTRACT

A dental apparatus and method of dental reconstruction are provided in which an implant (10) includes a collar (12) extending from a base (14). The collar (12) provides a platform for attaching dental fixtures, such as crowns or abutments (30). The collar (12) may be shaped so as to allow bone and gum growth that matches natural structures.

### TECHNICAL FIELD OF THE INVENTION

This invention relates generally to dentistry, and in particular to methods and apparatus for dental implants.

### BACKGROUND OF THE INVENTION

For a variety of reasons, the loss of human teeth and related bony support structures is often a very difficult experience. In addition to the functional problems that result from such loss, significant emotional and psychological stresses are associated with the concerns about physical appearance and the ability to live, eat, and smile as normal, that arise after tooth loss.

In an effort to address these issues, many people turn to dental reconstruction to replace teeth. One class of replacements uses dental implants as tooth root replacements in the jawbone, with crowns, which resemble teeth and gums, attached to the implants. The present invention relates to that class of replacements.

The primary considerations in dental reconstruction are function, comfort, strength, aesthetics, and hygiene. Unfortunately, in many cases compromises must be made to one or more of these considerations to accommodate another. For example, to ensure that the reconstruction does not create hygienic problems, the crown must often be made with a non-anatomical emergence profile. Simply stated, the crown may not have the shape of a natural tooth. As another example, hygiene and aesthetics may be compromised to ensure adequate strength, such as when multiple implants are required.

Also, dental professionals are in need of devices and methods that increase the probability of successful reconstruction, and which can be implemented efficiently and without complicated parts and multiple steps.

Therefore, a need has arisen for a dental implant and method of dental reconstruction that reduces or eliminates these problems.

### SUMMARY OF THE INVENTION

In accordance with the teachings of the present invention, a dental device and method of dental reconstruction are provided which eliminate or substantially reduce the problems associated with prior art systems.

In particular, a dental apparatus is provided that comprises a base proximate a jawbone, and a collar (or platform) extending from the base. The base may have a wide profile, or may be narrow, such as, without limitation, a conventional stabilizer. In particular embodiments, the collar has, at least in part, a concave shape. Also, the collar may include shoulders to facilitate creation of interdental papillary structures, for example by providing support for bone created from a bone graft. In general, the collar has a rim that may define a non-planar surface. The collar may be coupled to bone or to bone graft material, such that the collar aids in securing the dental apparatus. The plan view of the collar may be in the shape of a natural tooth, allowing osseous graft to mimic the natural tooth root form. The base may include anti-rotational features on its outside surface. Also, the collar may be formed integrally with or be a separate piece coupled to the base.

In a particular embodiment, an abutment is provided, and the collar is formed by a bone-side of the abutment. The bone-side of the abutment has a rim that may define a non-planar surface. Also, the base may be a conventional stabilizer.

In particular embodiments, at least a part of the collar lays on bone or bone graft material. Also, bone graft material may be placed between the jawbone and the collar. Furthermore, the base may be at least partially set into the bone or bone graft material.

In some embodiments an abutment is coupled to the dental apparatus. Also, a crown may be coupled to the abutment. Furthermore, the base may include a bore, and an abutment coupled to the base via the bore. Also, a dental fixture such as a crown or bridge may be directly coupled to the dental apparatus.

To assist in stabilizing the dental apparatus, several embodiments include stabilizers, some of which may extend from the collar into bone, or pass through a hole in the collar into bone, or pass through a hole in the base. Also, a stabilizer may be used that that includes an abutment.

A method of dental reconstruction is also provided, that comprises setting a base having a collar onto a jawbone, implanting a stabilizer, and attaching a dental fixture (such as, without limitation, an abutment, a crown, or a bar) to the base. In another embodiment, the method includes placing bone graft material or membrane between the jawbone and the collar. Furthermore, an abutment may be attached to the base. In one embodiment of the method, attaching a dental fixture comprises attaching a crown to the abutment. In some embodiments, the dental fixture is an abutment, a crown, or a bar. In particular embodiments, implanting the stabilizer comprises implanting the stabilizer through the collar or through the base.

In another embodiment of the apparatus of the present invention, a plate is coupled to a jawbone, with the plate including a fitment adapted for coupling to a dental fixture. One or more stabilizers are used to couple the plate to the jawbone. In a particular embodiment, at least a part of the plate lays on bone, or on bone graft material between skeletal bone and the plate.

Important technical advantages are provided by the present invention. In particular, the collar of the present invention allows for a relatively wide base for rigid coupling of dental implants to bone or bone graft. This stability significantly increases integration, functionality, and strength of implants, and provides a platform for creating comfortable, aesthetically pleasing, and hygienically sound dental reconstructions. Also, the base of the present invention, being preferably round, allows for simple preparation of the implant site.

Another important technical advantage of the present invention is that the collar may have a contoured shape, such as, without limitation, one having rolled or curved shoulders, which allows for bone and gum creation that matches natural interdental papillary and general tooth/bone/gum structures. In particular, a surgeon can effectively raise the interproximal bone height of the ridge with a bone graft, and thus restore interdental papillae, because the bone graft (such as, without limitation, block bone graft or bone graft particles) will bond to the collar, thus matching its contour, with the collar acting as support for the bone.

Moreover, the collar and base from which it extends serve as a wide platform (having any desired shape) to which a dental fixture, such as a crown, bridge, or abutment for attachment of a crown or bridge, can be affixed. This wide platform allows the crown (and the collar itself and any abutments) to be shaped as desired, for example, to have a natural anatomical emergence profile for whatever tooth (teeth) it is replacing, thus enhancing aesthetic appearance and function, and avoiding many hygienic problems indicative of prior art cylindrical implants. This platform also allows for broader distribution of oblique forces (into the implant and surrounding bone) generated during mastication than in typical prior art systems, where forces are concentrated on a much smaller concentric diameter of the prior art implants. This collar (platform) can provide a scaffold-like support to re-create original dimensions of a natural tooth root. For example, in situations where the implant is placed in or near a residual or resorbed socket (which is often atrophied (shrunken dimensionally)), this platform supports the re-creation of the bony architecture both around the platform and longitudinally along the root.

### BRIEF DESCRIPTION OF THE DRAWINGS

Reference is made in the description to the following briefly described drawings, which are not drawn to scale, with certain features enlarged for clarity, in which like reference numerals indicate like features:

FIG. 1 illustrates a particular embodiment of an implant according to the teachings of the present invention;

FIG. 2 illustrates a particular embodiment of a stabilizer;

FIG. 3 illustrates a particular embodiment of an abutment for use with the implant of FIG. 1;

FIG. 4 illustrates a side sectional view of a particular embodiment of an abutment coupled to a particular embodiment of an implant;

FIG. 5 illustrates another embodiment of a stabilizer with an abutment;

FIG. 6 illustrates another embodiment of an implant according to the teachings of the present invention;

FIG. 7 illustrates another embodiment of an implant according to the teachings of the present invention;

FIGS. 8a and 8b illustrate another embodiment of an implant according to the teachings of the present invention;

FIG. 9 illustrates a plan view at section line 9 of FIG. 8a;

FIG. 10 illustrates a plan view of another embodiment according to the teachings of the present invention;

FIG. 11 illustrates one type of site that may be reconstructed;

FIG. 12 illustrates a PRIOR ART solution;

FIG. 13 illustrates a perspective view of one embodiment of an implant according to the teachings of the present invention; and

FIG. 14 illustrates a perspective view of one embodiment of an implant and crown according to the teachings of the present invention.

### DETAILED DESCRIPTION OF THE INVENTION

This application is related to co-pending U.S. patent application Ser. No. 09/968,228, which is incorporated herein by reference, in its entirety.

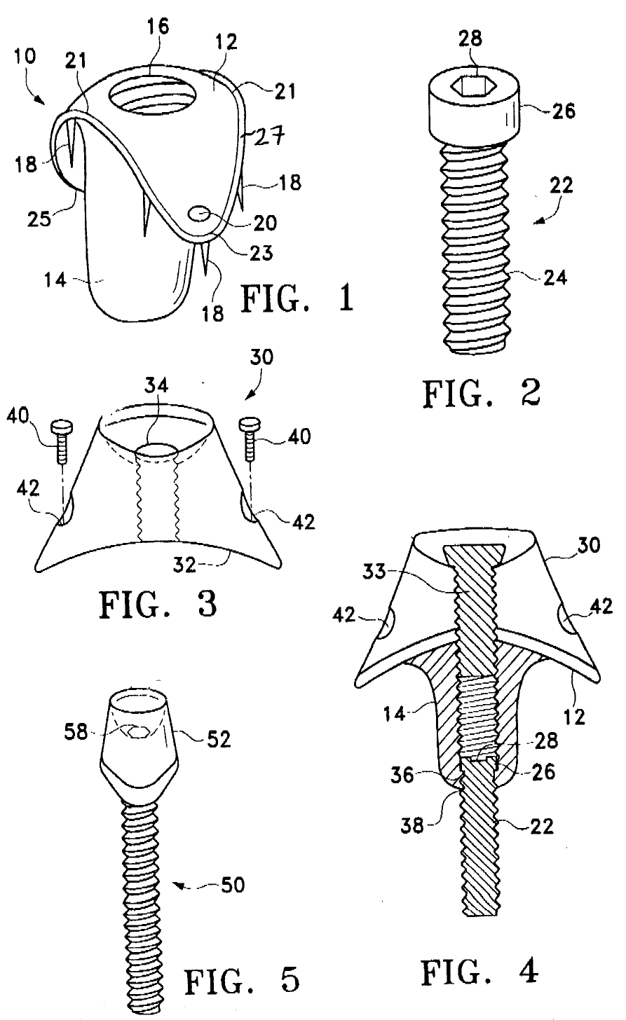

FIG. 1 illustrates a particular embodiment of implant 10 according to the teachings of the present invention. Implant 10 includes a collar (or platform) 12 that extends from a base 14. Collar 12 may have any shape, and in particular, without limitation, is advantageously shaped to conform to the cross section of the root(s) being replaced and to allow for the creation of interdental papillary structures. In the particular embodiment shown, base 14 is shaped to be set (at least partially) into a patient's jawbone (for example, without limitation, following a cylindrical osteotomy or into an existing socket (whether the socket is intact or not)), providing significant stability. Also illustrated is a bore 16 passing through the top of the implant 10. Bore 16 allows for a stabilizer, to be discussed below in connection with other FIGURES, to further fix the implant 10 to the patient's jawbone, if such a stabilizer is appropriate. Also, bore 16 may be adapted, as with threads, to receive a dental fixture, such as, without limitation, a crown, a bridge, or an abutment to which a crown or bridge can be attached.

The collar 12 is preferably formed integrally with the base 14, but may be a separate piece, for example, without limitation, one that is coupled to the base 14 such as with a coupling screw. Collar is meant to include, without limitation, any structure that extends from the base. Also, although the base 14 is preferably relatively wide to provide stability, a narrow base, such as, without limitation, a screw or other conventional stabilizer, may be used as the base 14.

The base 14 preferably has (although need not have) a round cross section, allowing an implant site to be prepared (where necessary) with a simple cylindrical osteotomy, or the implant to be simply screwed in. Thus, the present invention provides, with its collar 12, a broad platform that may be eccentrically shaped like natural teeth, and yet allows simple cylindrical site preparation.

As shown in FIG. 1, the collar 12 may include spikes 18 that may extend from the collar 12 towards the jaw of the patient. These spikes 18 serve to provide additional stability by tacking the collar to the jawbone (or bone graft material) of the patient when the implant 10 is placed, for example by tapping it into the site. Throughout this disclosure, reference may be made to a patient's jawbone (or bone) or to bone graft material. These terms may be used interchangeably, and the bone graft material, if any, is considered part of the patient's jawbone, unless the context indicates otherwise. Thus, use of the terms bone or jawbone includes bone alone, bone graft, or bone with bone graft. The bone graft material may be any kind of bone graft material, including, without limitation, block bone or bone particles of any kind, either of which may be coated with or mixed with platelet rich plasma (“PRP”) to facilitate healing. The spikes 18 may also serve as spacers to facilitate the introduction of bone graft material between the patient's jawbone and the collar 12. Thus, the spikes are considered stabilizers or spacers. Although spikes 18 are shown, no such spikes (or spacers) are required. Furthermore, any other device may be used to assist in stabilizing the collar 12 to the patient's jawbone or bone graft material introduced between the patient's jawbone and the collar 12. For example, without limitation, a titanium mesh or strap may be coupled to the collar 12 for coupling the implant 10 to the patient's jawbone or bone graft material, as could one or more bone screws.

The collar 12 of the present invention may serve, among other functions, to provide a relatively wide platform for stable coupling of the implant 10 to the patient's jawbone. Bone graft material may be used to build up the patient's jawbone in the location of the implant 10, under and around the collar 12. However, no such bone graft material is required. The stability provided by the relatively wide platform of implant 10 (provided by either or both of the base and the collar) significantly increases the functionality and strength of this implant over prior art implants, and creates comfortable, aesthetically-pleasing, and hygienically-sound dental reconstructions. The broad profile allowed by the shape of the collar 12, along with setting of the base 14 into the jawbone, allows for more even distribution of oblique forces generated during mastication than in typical prior art systems (where forces are concentrated on a narrow implant). With the present invention, the forces are broadly distributed to the surrounding bone.

The components described throughout this description are preferably made of surgical grade titanium, although other material can also be used. The surfaces may be smooth, or may be roughened, etched, pitted, or otherwise produced with features for facilitating osseointegration, such as, without limitation, barbs, ribs, waists, mesh structures, or inverted ribs.

FIG. 1 also illustrates a hole (with another hole unshown) 20 passing through the collar 12, near the lobes of the collar 12. One or more holes 20 (which may be threaded) may be provided, but are not required, to allow fixation screws to pass through the collar 12 and fix it to the patient's jawbone or bone graft material, if appropriate for the particular reconstruction.

The shape of collar 12 shown in FIG. 1 illustrates another important advantage of one embodiment of the present invention. With a curved shape as shown in FIG. 1, bone graft material can be packed between the collar 12 and the jawbone and around the collar 12 in a shape that matches the natural anatomical topology of bone and tooth structures. In particular, the interproximal bone height of the ridge can be raised with the bone graft (near the regions (or shoulders) 21 shown on collar 12), thus restoring interdental papillae as gum tissue heals over the graft, because the bone graft (such as, without limitation, block bone graft or bone graft particles) will bond to the collar along its contour, with the collar acting as support for the bone. This new structure is similar to the natural structure supported by natural tooth roots and bone, and fills in unsightly spaces that often exist between crowns or between teeth and crowns when prior art implants are used. By using titanium, or any other material that bonds to bone, with the shape shown in FIG. 1, natural papillary and general tooth/bone/gum structures are easily reproduced. As discussed, the shape of the illustrated collar includes raised regions 21. To facilitate the recreation of interdental structures, the top surface of the collar (the surface that is coupled, directly or indirectly, to a dental fixture such as, without limitation, an abutment or a crown) includes an intermediate section that is raised from the patient's ridge farther than a lip end 23 or tongue end 25 of the surface (the ends that are, respectively, closest to the patient's lip and tongue) is raised from the ridge. However, it should be understood that the particular shape shown is exemplary only, and any appropriate shape may be used. In general, the collar has a rim that preferably forms a surface that is non-planar. Although the non-planar surface is preferable, the collar may also form a flat surface.

Furthermore, the collar 12 may be shaped (in its plan view) to have a natural anatomical emergence profile, and a crown or abutment may extend, if appropriate, to the perimeter of the collar 12, thus allowing replacements that have very natural appearances.

Also, the present invention facilitates quicker completion of reconstructions, by allowing the site to be prepared (where needed) with bone graft material and the implant to be implanted, all at one time. This often takes two or more office visits, with time for healing in between, with prior art implant systems. A crown that may be coupled to the implant 10 may be shaded as desired, depending on the site. For example, the portion of the crown nearest the base 14 may be colored gum color, and then tooth color beyond the gum line. Similarly, the base 14 and collar 12 may be colored (as well as abutments described below), for example with gum or tooth colors, as desired.

The particular collar 12 shown in FIG. 1 is shaped with two lobes (near holes 20). However, it should be understood that this is exemplary only, and other shapes may be used without departing from the intended scope of the present invention. Furthermore, the collar 12 is shown as being concave from the bone side (convex when viewed from the crown side). The collar should be shaped as required for the particular reconstruction for which it is intended, and thus will usually be shaped so as to increase stability of the implant and to support bone growth that is similar to naturally shaped bone or root structures. In many cases, this results in a concave shape (from the bone side) for the collar 12. As a non-limiting example, the concavity may range from being subtle to a rather pronounced U-shape (such pronounced shape being desirable in (but not limited to) situations where there is a narrow alveolar ridge). Also, in cases where there is a relatively narrow ridge, where significant bone grafting is required, or where stability concerns otherwise make it appropriate, a strap (preferably made of titanium), mesh, or other coupling device may be used to tie the collar to the bone graft below (which may be bone particles or block bone).

Collar 12 has a rim (or edge) 27. The rim 27 may be raised from the top surface of collar 12. However, the rim 27 need not be raised. With a raised rim, a recess is formed (by the raised rim and the top surface of collar 12). Although the raised rim and recess are not required, they allow for an excellent interface between a crown, abutment, or other dental fixture and the collar 12. A tight interface is advantageous in avoiding buildup of bacterial contamination. Furthermore, the recess and raised rim may provide a retainer for material, such as, but not by way of limitation, metal, plastic, ceramic, or glass-filled resin, that may be used to build an appropriate site for fixation of a crown, abutment, or other dental fixture to the collar 12. Also a gasket or rubber o-ring may be employed, for example near the rim 27, to further assist in blocking bacterial contamination, which contamination can result in odor problems.

FIG. 2 illustrates a stabilizer 22 that may be used in connection with an implant 10 such as that shown in FIG. 1. Stabilizer 22 includes a threaded shaft 24 and a head 26. The stabilizer 22 passes through the bore 16 and couples the implant 10 to the patient's jawbone. As will be illustrated below in connection with FIG. 4, implant 10 may include (but need not) internal shoulders against which head 26 abuts. The stabilizer 22 may thread into the implant 10 as well as bone. Head 26 may be the same or a different diameter than the shaft 24. Head 26 may also include a fixture 28, which is illustrated as a hexagonal void, for receiving a drill bit. Although a hexagonal fixture 28 is shown, any suitable device may be used for facilitating driving of the stabilizer 22, including, without limitation, internal or external elements. Also, the bore 16 may be a recess-like structure, and a crown, abutment, or other dental fixture may be coupled to the stabilizer 22 or implant 10 through the recess. Also, the head 26 of the stabilizer 22 may include an integrally formed or separately attached abutment, to facilitate direct crown attachment to the implant 10. The shaft 24 may be tapered or stepped down in diameter. As a non-limiting example, with a stepped-down embodiment, the wider diameter section may thread into the implant, and the narrower section may thread into a narrower part of the implant (or simply pass through the implant), and then into bone.

Although the base is preferably as shown in FIG. 1, and is stabilized with a stabilizer such as is shown in FIG. 2, the base itself may also be a stabilizer, such as, without limitation, a threaded screw, to which a collar is coupled or on which a collar is integrally formed. Stabilizer is meant to be a broad term, including, without limitation, any structure that assists in securing the dental implant to the patient's jawbone, whether as a primary securing member, a secondary member, a temporary setting member, or otherwise, such as, without limitation, screws, adhesion rods, bone extenders, tacks, straps, pins, nails, rods, bars, fasteners, or other devices.

Referring now to FIGS. 3 and 4, a particular embodiment of an abutment 30 is illustrated for use with the implant 10. As discussed herein, crowns or other dental fixtures can be attached directly to the collar 12 without the need for abutment 30 (indeed, collar 12 may be shaped in any way so as to facilitate such attachment, and may include an integrally formed abutment). However, this description of abutment 30 (to which a crown or other dental fixture is attached) provides another example of using the collar 12 of the present invention.

As can be seen in FIG. 3, the bottom side 32 of abutment 30 has a shape that conforms substantially to that of collar 12. Abutment 30 is shown as being relatively tall, but may be very short (thin), depending on the needs of the case, and may be contoured as desired to facilitate appropriate reconstruction. Abutment 30 may be coupled to the implant 10 by use of a coupling screw 33 (shown in FIG. 4) that is threaded through a bore 34 of abutment 30. Such a coupling screw also threads into the bore 16 of implant 10. Also, the coupling screw may pass all the way through the base 14 and into bone to serve as a stabilizer as well. However, abutment 30 may be coupled to implant 10 in other ways, as well, and may be formed integrally with the implant 10, thus avoiding the need to couple them.

FIG. 4 illustrates a side sectional view of the abutment 30 of FIG. 3 coupled to the implant 10. As illustrated, stabilizer 22 passes through the bore 16 and couples the implant 10 to the patient's jawbone. The head 26 of stabilizer 22 abuts shoulders 36 that are on the inside of implant 10. Shoulders 36 narrow bore 16 down to a hole or passageway 38 through which the shaft 24 of stabilizer 22 passes. The passageway 38 may be threaded to accommodate the threaded stabilizer 22. However, the threaded stabilizer 22 is exemplary only, and any suitable features may be used on the stabilizer 22 which will facilitate osseointegration, such as, without limitation, ribs, waists, or inverted ribs. Furthermore, the stabilizer 22 may be set into the bone in many ways, including, but not limited to, by screwing or tapping. However, it should be understood that the scope of the present invention as described in connection with all embodiments herein, includes stabilizers with or without such features, and any device for securing the base 14 to the bone is considered a stabilizer. Furthermore, the bone ends of the stabilizers (such as the stabilizers shown in FIGS. 2, 4, and 5) may be narrower, such as by tapering or stepping down, than the rest of the shaft of the stabilizer, and may be roughened to facilitate osseointegration. Furthermore, the pitch of the threads on the bone end of such stabilizers may be slightly different than that of the rest of the stabilizer, so as to facilitate osseointegration. However, no such variations are required.

Also shown in FIG. 3 are fixation screws 40. Fixation screws 40 may be used to couple the abutment 30 to the collar 12, for example by threading through holes 42 of the abutment 30 and then into holes 20 of the collar 12. However, no such fixation screws 40 are necessary. Furthermore, the fixation screws 40 may pass all the way through holes 20 into the bone or bone graft material of the patient. Such fixation screws 40, if used, may be used with or without the coupling screw 33 and bore 34, or other approaches.

Also, the bottom side (bone side) 32 of abutment 30 may serve as the collar itself, in which case no other collar is required. For example, coupling screw 33 may be used to couple the abutment/collar to the base, or the abutment and base could be formed integrally. The base, as discussed above, may be wide or narrow (such as a conventional stabilizer). Where bone graft material is used, it is packed between the abutment 30 and the jawbone when the abutment is the collar. This abutment/collar may have the shapes discussed in connection with the other embodiments described herein (such as, without limitation, the non-planar shape or the eccentric emergence profile), so as to provide the benefits of those shapes. Thus, the scope of the present invention includes, without limitation, a conventional stabilizer (such as a threaded shaft) and an abutment (whether they are separate pieces coupled together or one integrally formed piece), where the abutment is shaped as described as provided herein, such as where the bone side of the abutment is a collar that has a rim that forms a non-planar surface.

FIG. 5 illustrates an alternative to the embodiment shown in FIGS. 2 and 3. As shown in FIG. 5, a stabilizer 50 may be provided with an abutment 52 formed integrally with or coupled to the stabilizer 50. Stabilizer 50 passes through implant 10 to couple it to the patient's jawbone and to provide the abutment 52 for coupling to a crown or other dental fixture. As shown in FIG. 5, abutment 52 may include a feature 58, which may be an internal or external feature, to facilitate driving of the stabilizer 50 into to patient's jawbone.

The collar 12 may also be cross-sectionally shaped in an anatomical way, thus allowing a natural shape to flow from the collar 12 to the crown. Moreover, the crown may be attached directly to the collar 12, obviating the need for a separate abutment like that of FIG. 3. In such a case, the crown may be fixed to the collar 12 through features or abutments formed integrally on or coupled to the collar 12 or the head of the stabilizer 22.

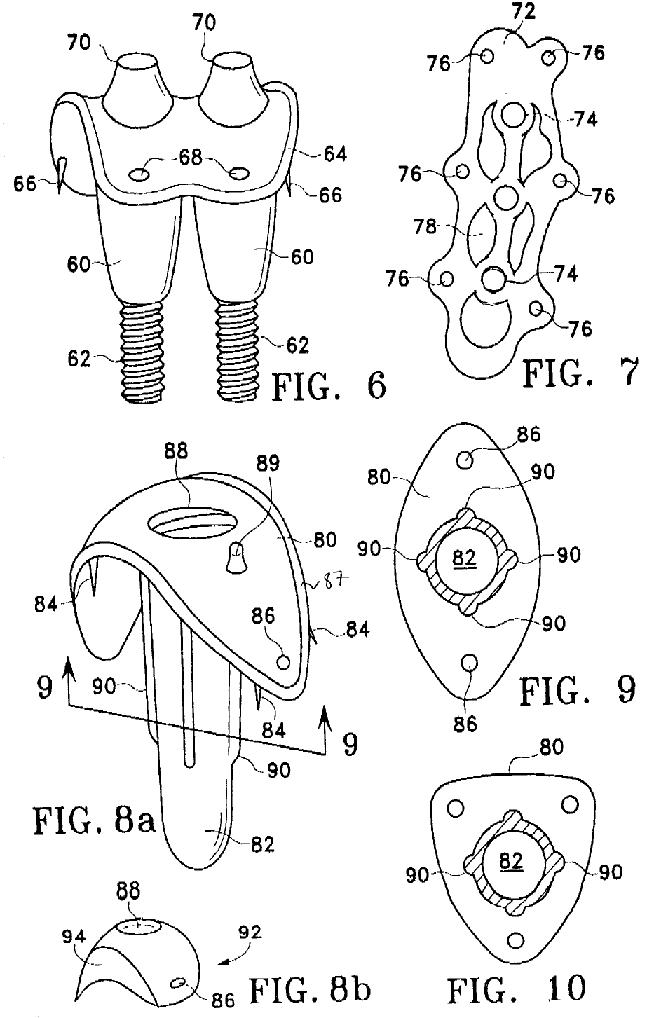

FIG. 6 illustrates another embodiment of the present invention, which includes two integral bases 60 through which stabilizers 62 pass. This double-base embodiment is provided to illustrate the flexibility of the present invention. With the double-base embodiment, large reconstructions may be performed, for example for replacement of a large tooth (although more than a single-base is not required for replacing large teeth), such as a molar, or where several teeth need to be replaced. Although the particular example shown in FIG. 6 is a double-base embodiment, more than two bases and stabilizers may be used. As shown in FIG. 6, a collar 64 extends from the bases 60. Collar 64 serves to provide a stable platform for the implant, as discussed above in connection with the previous FIGURES. Also shown are exemplary tacks 66, such as those discussed above in connection with elements 18 of FIG. 1. Also, holes 68 (which may be threaded) are provided, if necessary, to accommodate fixation screws for fixing the collar to the patient's jawbone. In the particular example shown in FIG. 6, a head 70 of the stabilizer 62 is the abutment 52 of the stabilizer 50 shown in FIG. 5. As an alternative, the bases 60 may be formed such as that discussed in connection with FIG. 4, in which an internal stabilizer such as that shown in FIG. 2 is used to fix the implant to the patient's jawbone. Then, an abutment or other dental fixture can be threaded into the bases 60 (or otherwise coupled to the bases 60 or collar 64), for example through a threaded bore 16 such as that shown in connection with FIG. 1. An abutment like that of FIG. 3 may be used, but shaped to cover both bases 60, and may be shaped as discussed above to create natural emergence profiles and interdental structures. Also, the abutment may be omitted, and the crown or other dental fixture attached directly to the collar and base.

FIG. 7 illustrates an alternative embodiment of the present invention in which a collar (or plate) 72 is provided for fixation to a patient's jawbone. The collar 72 includes one or more fitments 74, which may be threaded, for example, for receiving an abutment or other dental fixture. Also, the fitments 74 may receive a stabilizer for coupling the collar 72 to the patient's jawbone. As an example, a stabilizer like stabilizer 50 of FIG. 5 could be threaded through the fitment 74. However, with the particular embodiment shown in FIG. 7, no stabilizer is required to be passed through the fitment 74. Instead, a dental fixture or abutment can be threaded into the fitment 74, with collar 72 fixed to the patient's jawbone with fixation screws or other devices, for example through the holes 76.

Although the embodiment shown in FIG. 7 includes three fitments 74, it should be understood that more or fewer receivers may be used. In typical applications, the collar (or plate) 72 of FIG. 7 will have bone graft material sandwiched between it and the patient's jawbone, and packed around, over, and through the webs of plate 72, to insure stable coupling to the patient's jawbone. The collar 72 in FIG. 7 shows web-like features that allow the bone graft to pass through and around the collar 72 to assist in stabilization. While this arrangement is preferred, no webs need be included. By webs, it is meant that plate 72 includes voids for the bone graft material to pass through, such as void 78 shown in FIG. 7. Indeed, other shapes, such as a grid or metal framework may be used to create the plate 72 and support the fitments 74. Also, the plate 72 may be shaped with shoulders, such as discussed above, to facilitate interdental bone growth and gum growth structures. In typical applications, the embodiment shown in FIG. 7 would be used to replace several teeth, such as in an edentulous quadrant, or a part of or all of an arch.

FIG. 8a illustrates another embodiment of the present invention wherein an implant includes a collar 80 and base 82. With the embodiment shown in FIG. 8a, base 82 is tapped or otherwise inserted into the patient's jawbone, at a site that has either been prepared by a dental professional, or perhaps into an existing root socket. No stabilizers such as those shown in FIGS. 2 and 5 are needed with the embodiment shown in FIG. 8a. Collar 80 may include spikes 84 such as those discussed above in connection with the other embodiments, and may also be fixed to the jawbone by fixation screws inserted through holes 86, such as those discussed above in connection with the other embodiments. The implant of FIG. 8a also includes a receiving port 88 for receiving an abutment or other dental fixture. An abutment such as that shown FIG. 3 may be coupled to the implant of FIG. 8a as discussed in connection FIGS. 3 and 4. Similarly, an abutment somewhat like that of FIG. 5 may be threaded into the receiving port 88 to accommodate fixation of a crown or other dental fixture to the abutment.

Furthermore, the rim 87 of collar 80 may be raised from the top surface of the collar 80, thus defining a recess proximate the rim to facilitate attachment of a crown, abutment, or other dental fixture. However, it is not required that the rim 87 be raised. The advantage of the raised rim and corresponding recess are described above in connection with rim 27. The collars discussed above in connection with the other FIGURES may also include raised rims.

It should be understood that no port 88 is required (although it could be used), and a crown or other dental fixture may be coupled to the collar in other ways. For example, without limitation, features, such as abutment 89 or threaded screw holes, may be formed integrally on the collar 80 to facilitate attachment of the crown (or other dental fixture). This attachment approach can also be used with the other embodiments described herein, including, without limitation, those of FIGS. 1 and 6.

FIG. 8b illustrates another embodiment of a collar, collar 92, according to the teachings of the present invention. This collar 92 may be used with the embodiment of FIG. 8, or any of the other embodiments described or illustrated herein, including, without limitation, with the embodiments of any other FIGURE or where an abutment forms the collar. The collar 92 may include the features of collar 80 or the other collars described herein, such as spikes 84, holes 86, port 88, rim 87, or the abutment 89 or threaded screw holes. The collar 92 is similar to the others described herein, but shows that sides of the collar may be broadened to provide a relatively large surface to facilitate bonding of bone graft to the collar and thus to provide bone support. The sides of any of the collars described herein may also be slanted toward or away from the base of the implant, as appropriate. Also, such broadened sides may be used in connection with the embodiment of FIG. 7.

FIG. 9 illustrates a cross-sectional plan view taken along the line labeled 9 in FIG. 8a. As shown in FIG. 9, the base 82 includes anti-rotational ribs 90 that assist in stabilizing the base 82 into the patient's jawbone. These ribs 90 extend outwardly and seat within receiving grooves that are prepared by the dental professional in the jawbone site for receiving the implant, which grooves substantially conform and receive these ribs 90. Although features that prevent rotation, such as these anti-rotational ribs 90, are preferred, no such ribs are required. Furthermore, although four ribs are shown in FIG. 9, more or less than that may be used. Also, although ribs are shown, other features, including some horizontal and vertical, may be used to resist rotation or other movement of the implant within the patient's jawbone. Moreover, such anti-rotational or anti-movement features may be included on all the embodiments (such as those of FIGS. 1, 4, and 6) described herein.

FIG. 10 illustrates a cross-sectional view taken similarly to that of FIG. 9, but wherein the collar 80 is illustrated with three lobes rather than two. FIG. 10 is provided to illustrate that the collar shown in FIG. 8a (and the other collars such as described in connection with FIGS. 1-7) with two lobes is exemplary only, and other shaped collars (such as for differently shaped teeth like molars, incisors, bicuspids, and canines) may be used. Indeed, the collars may have any desired shape. Moreover, although the collars shown in FIGS. 1, 6, 8a, 8b, 9, and 10, are solid (other than the holes provided for screws), they can be formed with holes or mesh-like, to facilitate fixation with bone graft mixture.

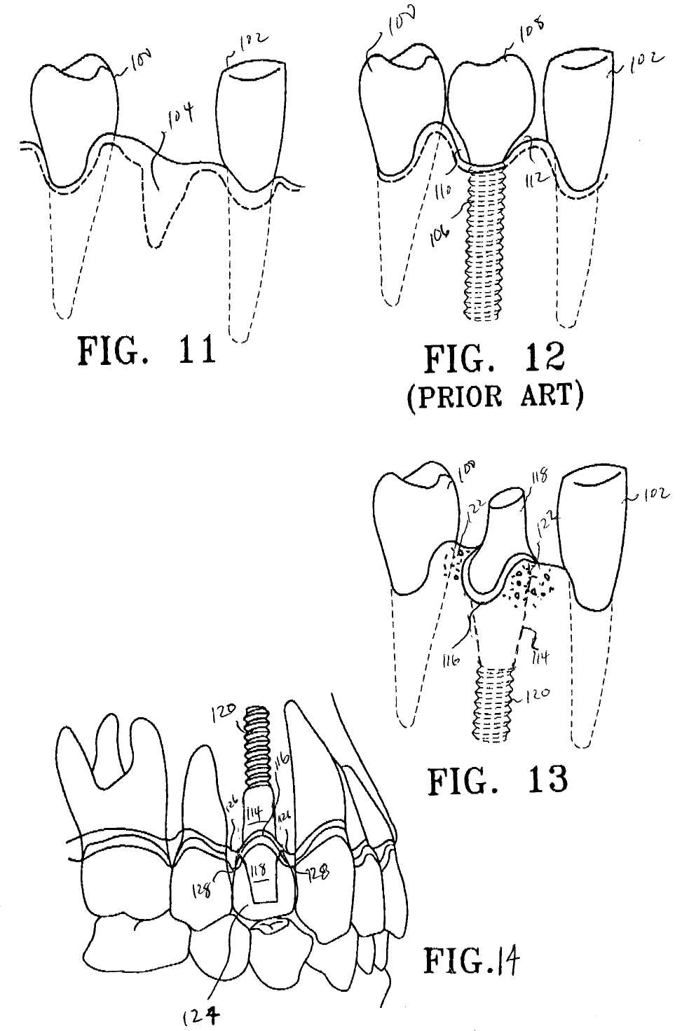

FIGS. 11-14 are provided to further illustrate the present invention. For purposes of illustration, FIG. 11 shows one kind of site that is encountered in reconstructive dentistry. This site is exemplary only, and many other sites, including, without limitation, those where whole arches are missing or where the bone is severely resorbed or missing, are appropriate for use of the present invention. As can be seen, natural teeth 100 and 102 surround a site of a missing tooth. The site of the missing tooth has a somewhat resorbed socket 104. FIG. 12 shows a prior art approach to reconstructing this site, in which a stabilizer 106 is implanted into the site, and a crown fixed to the stabilizer (either directly or with an abutment). As can be seen, gaps 110 and 112 are often created, resulting in an unsightly and sometimes hygienically problematic reconstruction. Indeed, sometimes the metal stabilizer can be seen, detracting significantly from the solution. Also, the narrow stabilizer 106 may not provide sufficient stability, thus resulting in discomfort and movement of the implant, and thus a failed replacement.

FIGS. 13 and 14 illustrate particular embodiments of the present invention and some of their significant advantages. As shown in FIG. 13, a base 114 is implanted into the site. Also provided is a collar 116. In the particular embodiment shown, an abutment 118 is provided to facilitate attachment of a crown or other dental fixture. A stabilizer 120 secures the base 114 to the jawbone. Bone graft material 122 is packed under and around the collar and base to build up the site. As discussed above, the collar and base provide support for bone graft material, and thus, with their contouring, allow growth of naturally shaped features, including interdental papillary structures.

FIG. 15 shows a crown 124 attached to the abutment 118. Also shown is the bone line 126 that is raised in the interdental spaces (facilitated by bonding with the contours of base 114 and collar 116), and thus supports a gum line 128, thereby providing interdental papillary structures. Also, the wide profile of base 114 and collar 116 provides excellent stability for the implant.

As part of the present invention, a set of standard shaped devices may be prepared for the professional to choose from. For example, the set may have variously shaped collars and abutments for bicuspids, molars, canines, and incisors, and different sizes for each shape, along with variously sized stabilizers. From this set, the professional chooses the parts that are appropriate for the particular case. As an alternative, the professional may have the devices custom made, after analyzing the case. In this latter alternative, the professional may have the devices prepared with the aid of a CAD milling machine or powder metallurgy, among other known methods of forming parts. In one particular approach, a core, for example made of acrylic, carbon fiber, titanium, or any suitable material, may be provided onto which titanium powder is applied to make the desired shape.

As an illustration of a custom approach, data on the shape of an extracted tooth, a socket or other site (including one as it will be after bone graft procedures), for example obtained from previous work on the site, proposed reconstruction, or from a laser or direct impression, or from X-rays, MRI, CT scan, impressions, or other techniques, is loaded into a CAD/CAM machine (computer). From this data, using a 3-D model, the computer designs an implant (collar, base and/or stabilizers) to match the site. The dental professional can then review and approve the design, and have it manufactured by the machine. Generally the pieces should then be passivated and sterilized, and are then ready for surgical placement. This all may happen within a short period of time, so that the measuring and implanting can occur at one office visit by the patient.

In general, the present invention may be used in most any kind of dental reconstruction case, and in particular, but without limitation, both in cases where there is need for bone reconstruction (such as where a socket area has resorbed) and where there has been a fresh tooth extraction (whether or not requiring bone reconstruction). Where there has been a fresh extraction, the extracted tooth or extraction socket may be used to select the proper pre-made implant, or to provide data for custom fabrication. If desired, the implant may be made slightly larger than the extracted tooth, to firmly fix the implant.

At the time of implant, the devices described herein may be coated with PRP and/or a PRP-bone matrix mix to facilitate fast generation of bone tissue for osseointegration.

Throughout the examples illustrated herein, the devices may include internal female or external male hexagonal elements for driving in and out. However, other approaches can be used for driving the devices. Also, the devices may be tapped into place. Also, the various holes, bores, and passageways may be tapered, or include shaped wells to accept beveled or matched heads on other parts. Features in each embodiment described herein can be interchanged with features in other embodiments. Also, certain materials, and approaches for fixing certain parts to others, have been illustrated. Others can be used without departing from the intended scope of the present invention.

And, in general, although the present invention has been described in detail, it should be understood that various changes, alterations, substitutions, additions, and modifications could be made without departing from the intended scope of the invention, as defined in the following claims.

What is claimed is:

1. A dental apparatus, comprising:
a base proximate a jawbone; and
a collar extending from the base.

2. The dental apparatus of claim 1, wherein the collar has, at least in part, a concave shape with respect to the jawbone.

3. The dental apparatus of claim 1, wherein the collar includes shoulders to facilitate creation of interdental papillary structures.

4. The dental apparatus of claim 1, wherein:
the collar includes a surface having a tongue end, a lip end, and an intermediate section between the tongue end and the lip end; and
the intermediate section is raised from the jawbone with respect to the lip end or tongue end.

5. The dental apparatus of claim 1, wherein the collar has a rim that defines a non-planar surface.

6. The dental apparatus of claim 1, and further comprising an abutment, and wherein the collar is formed by a bone-side of the abutment.

7. The dental apparatus of claim 6, wherein the base is a stabilizer.

8. The dental apparatus of claim 6, wherein the wherein the bone-side of the abutment has a rim that defines a non-planar surface.

9. The dental apparatus of claim 1, wherein the collar includes at least one side, the side having a surface for supporting a bone graft.

10. The dental apparatus of claim 1, wherein the collar is coupled to bone or bone graft material, such that the collar aids in securing the dental implant.

11. The apparatus of claim 1, wherein at least a part of the collar lays on bone or bone graft material.

12. The apparatus of claim 1, and further comprising bone graft material between the jawbone and the collar.

13. The apparatus of claim 1, wherein the base is at least partially set into the jawbone or bone graft material.

14. The dental apparatus of claim 1, and further comprising an abutment coupled to the dental apparatus.

15. The dental apparatus of claim 14, and further comprising a crown coupled to the abutment.

16. The dental apparatus of claim 1, wherein the base includes a bore, and an abutment is coupled to the base via the bore.

17. The dental apparatus of claim 1, and further comprising a dental fixture coupled to the dental apparatus.

18. The apparatus of claim 1, and further comprising a stabilizer extending from the collar.

19. The apparatus of claim 1, and further comprising a stabilizer passing through a hole in the collar.

20. The apparatus of claim 1, and further comprising a stabilizer passing through a hole in the base.

21. The apparatus of claim 1, and further comprising a stabilizer that includes an abutment.

22. The apparatus of claim 1, and further comprising anti-movement features on an outside surface of the base.

23. The apparatus of claim 1, wherein the collar is formed integrally with the base.

24. The apparatus of claim 1, wherein the collar is a separate piece coupled to the base.

25. The apparatus of claim 1, wherein the base is a stabilizer.

26. A method of dental reconstruction, comprising:
setting a base having a collar onto a jawbone;
implanting a stabilizer; and
attaching a dental fixture to the base.

27. The method of claim 26, and further comprising placing bone graft material between the jawbone and the collar.

28. The method of claim 26, wherein the collar has a side, and further comprising placing bone graft material against the side.

29. The method of claim 26, and further comprising attaching an abutment to the base.

30. The method of claim 29, and wherein attaching a dental fixture comprises attaching a crown to the abutment.

31. The method of claim 26, wherein the dental fixture is an abutment.

32. The method of claim 26, wherein the dental fixture is a crown.

33. The method of claim 26, wherein implanting the stabilizer comprises implanting the stabilizer through the collar.

34. The method of claim 26, wherein implanting the stabilizer comprises implanting the stabilizer through the base.

35. A dental apparatus, comprising:
a plate coupled to a jawbone, the plate including a fitment adapted for coupling to a dental fixture; and
a stabilizer coupling the plate to the jawbone.

36. The dental apparatus of claim 35, wherein at least a part of the plate lays on bone, or on bone graft material between bone and the plate.
